(19) United States
(12) Patent Application Publication
(10) Pub. No.: US 2007/0087312 A1
(43) Pub. Date: Apr. 19, 2007

(54) Method for separating sentences in audio-video display system

(75) Inventors: Tsuei-Chi Yeh, Hsinchu (TW); Tzu-Chuan Huang, Hsinchu (TW); Kuo-Chuan Li, Hsinchu (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: CHEERTEK INC.

(21) Appl. No.: 11/399,352

(22) Filed: Apr. 7, 2006

(30) Foreign Application Priority Data
Oct. 18, 2005 (TW) 094136275

(51) Int. Cl. G09B 19/00

(52) U.S. Cl. 434/156; 707/5; 434/157

(57) ABSTRACT

A method for separating sentences in an audio-video display system is disclosed, including the following steps. The detection of sentence labels: when the audio-video display system is playing, a subtitle decoder may use the information of a subtitle unit to detect the start time and finish time of a sentence, which are marked as sentence label; the management of sentence label: a circular buffer is provided to store the sentence label of the sentence and an index is maintained to access the buffer; the display of sentence label: when the audio-video display system is playing, an instruction of a control device can be used to retrieve the label of a sentence requested for displaying from the circular buffer and to display the sentence.

### FIELD OF THE INVENTION

The present invention relates to a method for separating sentences in an audio-video display system and particularly to a method for separating sentences in an audio-video display system, with which users can use a remote controller or input interface to accurately conduct repeat sentence, forward sentence, backward sentence, or directly jump to a certain sentence for playing to facilitate users to learn a language.

### BACKGROUND OF THE INVENTION

FIG. 1 schematically illustrates a block diagram of a conventional audio-video display system. As shown in FIG. 1, a conventional audio-video display system comprises a analysis device 10, a subtitle decoder 20, a video decoder 30, a video synthesizer 40, and an audio decoder 50. The analysis device 10 is to receive and decode audio-video bitstream from a DVD. After the bitstream is parsed, the subtitle bitstream is sent to the subtitle decoder 20, the video bitstream is sent to the video decoder 30, and the audio bitstream is sent to the audio decoder 50. Then, the video synthesizer 40 synthesizes the subtitle data decoded by the subtitle decoder 20 and the video data decoded by the video decoder 30 and then display the synthesized data on the screen. On the other hand, the audio decoder 50 outputs the audio data decoded through an audio output device, a speaker for example, in synchronization with the video decoder 30, such that users can enjoy the audio-video data of a DVD.

FIG. 2 schematically illustrates a conventional subtitle unit. The subtitle decoder decodes the information provided by a subtitle unit. A subtitle unit includes: 1 the series number of a subtitle unit (represented by * in the figure); 2 the start time and finish time of the subtitle unit (represented by ** in the figure); and 3 the content of a subtitle unit (represented by *** in the figure). As shown in the FIG. 3, the series number of the subtitle unit displayed is 2. The start time and the finish time is 00:00:23.000 and 00:00:26.500, respectively, i.e. the length of the subtitle unit is 3.5 seconds. The content of the subtitle unit is “Today is beautiful.” The content of a subtitle unit may comprise one sentence or more.

When users play a DVD for the first time, they usually know a certain sentence or a certain segment required further attention after they have actually finished the sentence or segment. As described above, if a sentence “Today is beautiful” appears on screen for the first time and users want to learn the sentence, they can use the repeat A-B function, i.e. press the button of repeat A-B to play the content between A to B point. Nevertheless, when users press the repeat A-B button, the sentence may have already been in the middle or even to the end of the sentence. Therefore, it is necessary to rewind to the beginning of the sentence and then select the point A to start the repeat A-B function. This process can cause a great deal of inconvenience for users intending to learn a language with the DVD.

Therefore, it is necessary to provide a method for separating sentences in an audio-video display system, with which users can use buttons of a remote controller or input interface to accurately conduct repeat sentence, forward sentence, backward sentence, or directly jump to a certain sentence for playing.

### SUMMARY OF THE INVENTION

An object of the present invention is to provide a method for separating sentences in an audio-video display system, of which subtitle decoder can detect the label of a sentence, which represents the start time and finish time of a sentence.

Another object of the present invention is to provide a method for separating sentences in an audio-video display system, of which the subtitle decoder store sentence labels in the circular buffer when the audio-video display system is playing.

Another object of the present invention is to provide a method for separating sentence in an audio-video display system, in which the subtitle decoder stores the label of the sentences displayed and the current displaying sentence in the circular buffer, respectively, and, in cooperating with an analysis device, pre-scans the labels of certain sentences before and after the current sentence and store them in the circular buffer, respectively.

Another object of the present invention is to provide a method for separating sentences in an audio-video display system, when the audio-video display system is playing, the sentence label requested for displaying can be retrieved from the circular buffer to conduct repeat sentence, forward sentence, backward sentence, or directly jump to a certain sentence for playing.

Accordingly, the method for separating sentences in an audio-video display system according to the present invention comprises the following steps: a circular buffer is provided; when the audio-video display system is playing, the subtitle decoder of the audio-video display system may use the information of a subtitle unit to detect the label of a sentence, which represents the start time and finish time of a sentence; the sentence label is stored in the circular buffer and an index is maintained to access the buffer; when the audio-video display system is playing, an instruction of a control device can be used to retrieve the label of a sentence requested for displaying from the circular buffer and to display the sentence.

Accordingly, the method for separating sentences in an audio-video display system according to the present invention comprises the following steps: a circular buffer is provided; when the audio-video display system is playing the current sentence, the subtitle decoder, in cooperating with an analysis device, pre-scans the labels of certain sentences before and after the current sentence to detect their labels which represents the start time and finish time of a sentence; the sentence labels are stored in the circular buffer and an index is maintained to access the buffer; when the audio-video display system is playing, the audio-video display system may retrieve the sentence label of a sentence which is requested for playing from the circular buffer and display the sentence.

### BRIEF DESCRIPTION OF THE DRAWINGS

The present invention can be more fully understood by reference to the following description and accompanying drawings, in which:

FIG. 1 is a block diagram of a conventional audio-video display system;

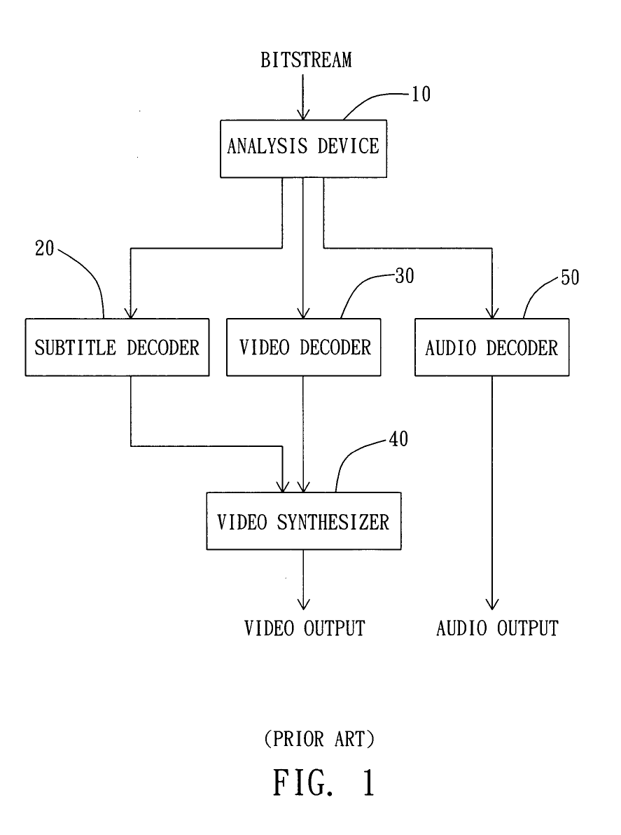

FIG. 2 is a schematic illustration of a conventional subtitle unit;

FIG. 3 is a block diagram of a preferred embodiment of the method for separating sentences in an audio-video display system according to the present invention;

FIG. 4 is a schematic illustration of the circular buffer 60 used in the audio-video display system according to the present invention;

FIG. 5 is a flowchart of the method for separating sentences in an audio-video display system of a preferred embodiment according to the present invention;

FIG. 6 is a schematic illustration of conducting repeat sentence in an audio-video display system of a preferred embodiment according to the present invention;

FIG. 7 is a schematic illustration of playing backward sentence in an audio-video display system of a preferred embodiment according to the present invention;

FIG. 8 is a schematic illustration of playing forward sentence in an audio-video display system of a preferred embodiment according to the present invention; and

FIG. 9 is a schematic illustration of jumping to play a certain sentence in an audio-video display system of a preferred embodiment according to the present invention.

### DETAILED DESCRIPTION OF THE INVENTION

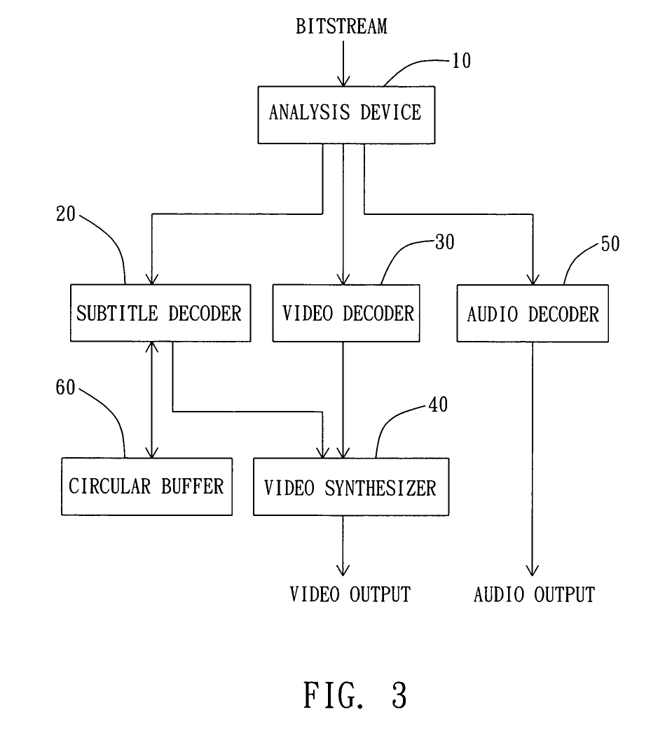

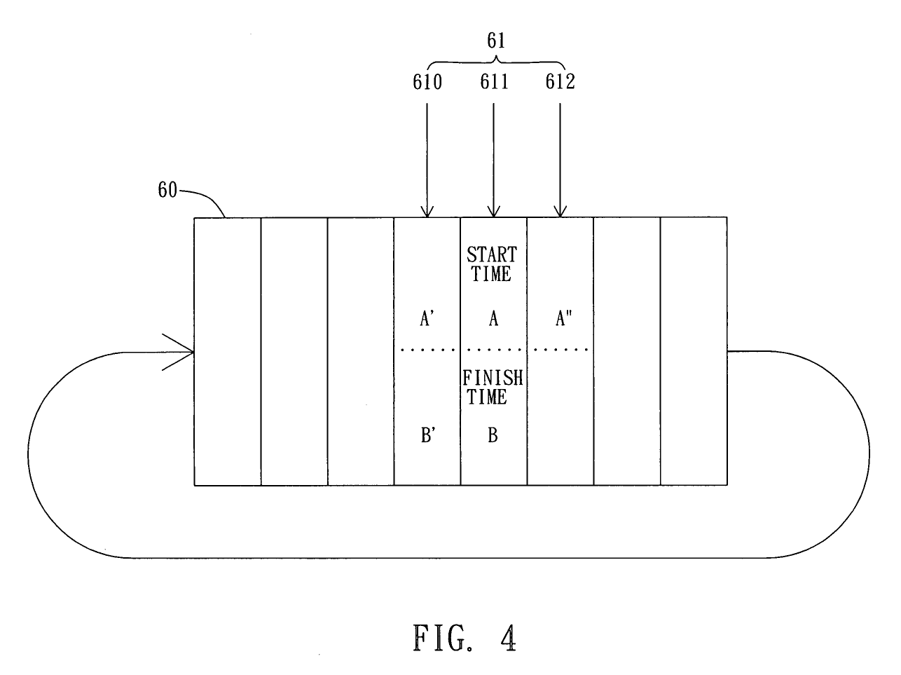

FIGS. 3 and 4 schematically illustrate the method for separating sentences in an audio-video display system and a circular buffer 60 used in the audio-video display system according to the present invention. As shown in FIG. 3, the difference between the audio-video display system according to the present invention and the conventional audio-video display system is the existence of the circular buffer 60. The circular buffer 60 coupled with the subtitle decoder 20 to store the start time and finish time decoded by the subtitle decoder 20. Wherein, the size of the circular buffer 60 is dependent on actual demand. The circular buffer 60 may comprise ordinary circular buffer memory or may be defined in an area of a ordinary memory by a programmable data structure.

Referring to FIG. 4, the circular buffer 60 further comprises an indexer 611 pointing to the current sentence label. From the indexer 611, an indexer 610 pointing to the last sentence, an indexer 612 pointing to the next sentence, and an indexer pointing to a certain sentence before or after the current sentence can be derived to facilitate the analysis device 10 to obtain the sentence label of the sentence requested for displaying. Furthermore, the circular buffer 60 is a circular buffer, in which new entering sentence label will replace the oldest sentence label.

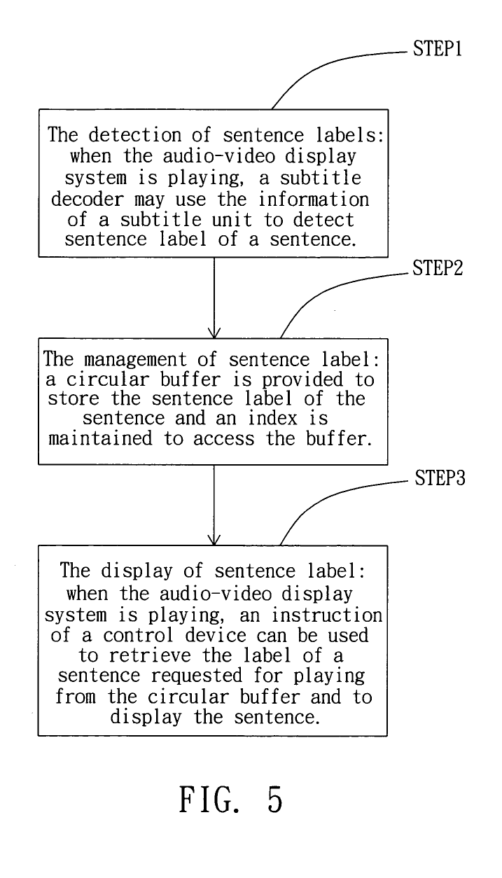

FIG. 5 schematically illustrates the flowchart of the method for separating sentences in an audio-video display system according to a preferred embodiment of the present invention. Referring to FIG. 5, the method for separating sentences in an audio-video display system according to the present invention includes the following steps. (step1) The detection of sentence labels: when the audio-video display system is playing, a subtitle decoder 20 may use the information of a subtitle unit to detect sentence label of a sentence; (step 2) the management of sentence label: a circular buffer 60 is provided to store the sentence label of the sentence and an index is maintained to access the buffer; (step 3) the display of sentence label: when the audio-video display system is playing, an instruction of a control device can be used to retrieve the label of a sentence requested for playing from the circular buffer 60 and to display the sentence.

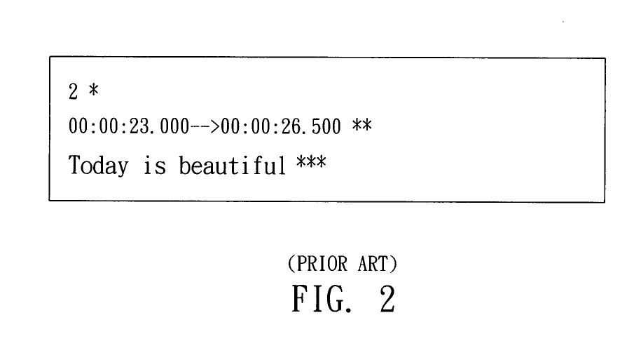

In step 1, the subtitle unit has the information shown in FIG. 2. The subtitle decoder 20 can decode the sentence label of the sentence with the information of a subtitle unit, which is input from the analysis device 10, wherein the sentence label is the start time and finish time of a sentence. The sentence “Today is beautiful” decoded in FIG. 2, for example, has start time and finish time of 00:00:23.000 and 00:00:26.500, respectively.

In step 2, the circular buffer 60 has the structure shown in FIG. 4, comprising indexers 610, 611, and 612, and the size of the circular buffer 60 can be adjusted to meet actual demand. For example, the start time and finish time of the current displaying sentence 00:00:23.000 and 00:00:26.500 are stored in the circular buffer 60, respectively and the indexer 611 points to the sentence label of the current sentence.

In step 3, the control device (not shown) may be buttons of a remote controller or input interface. The control device may provide users with the functions of Repeat Sentence (RS), Forward Sentence (FS), Backward Sentence (BS), and GoTo Sentence (GS) with a sentence as a unit.

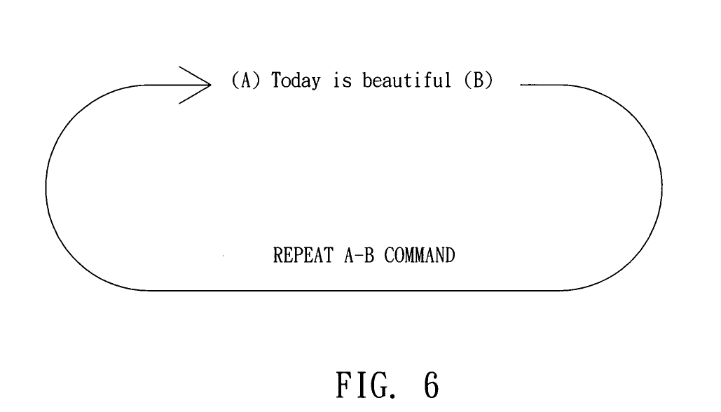

Referring to FIG. 6, when users press the command of Repeat Sentence (RS) for repeating the current sentence, the display system will retrieve the sentence label of the current sentence from the circular buffer 60 under the guidance of the indexer 611, i.e. the start time (00:0023.000) and finish time (00:0026.500). The start time is designated as A and the finish time, B. Then the sentence A-B can be repeated. Consequently, users can repeatedly hear the current sentence completely and quickly.

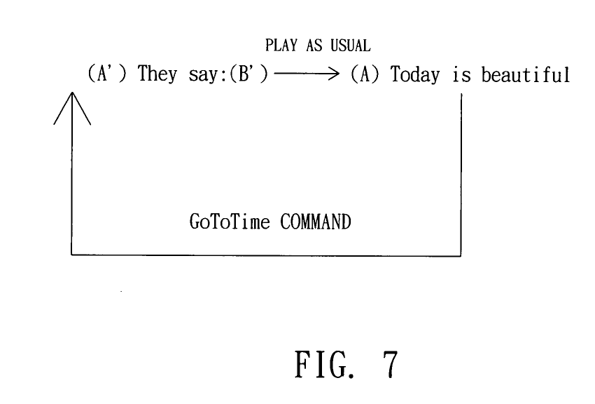

Referring to FIG. 7, when users press the command of Backward Sentence (BS) for playing the last sentence, the display system will retrieve the start time of the last sentence from the circular buffer 60 under the guidance of the indexer 610, and jump to the start time A′ (GoToTime) of last sentence. The display system will then play as usual.

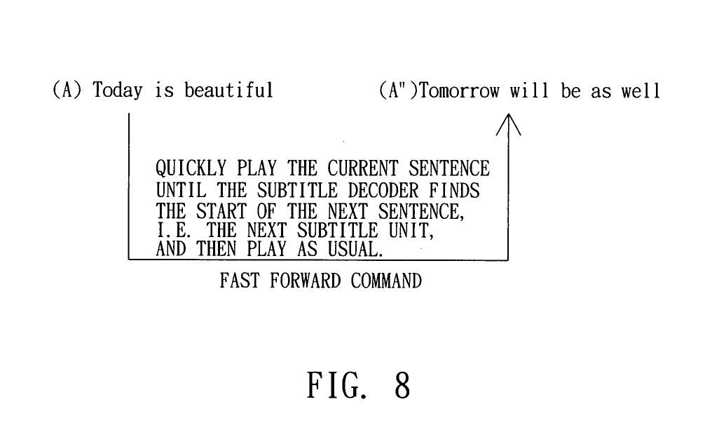

Referring to FIG. 8, when users press the command of Forward Sentence (FS) for playing the next sentence, the display system will quickly play the current sentence until the subtitle decoder 20 finds the start of the next sentence, i.e. the next subtitle unit, and then play as usual.

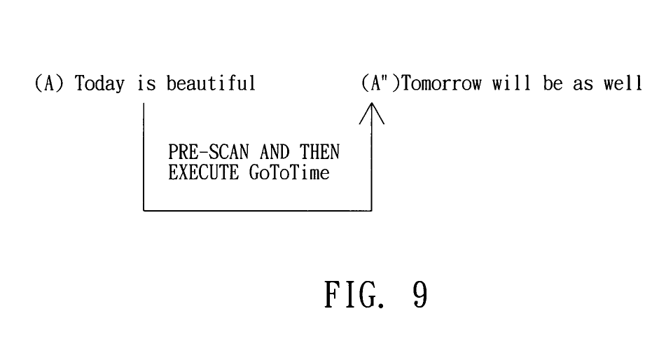

Referring to FIG. 9, when users press the command of GoTo Sentence (GS) for playing a certain sentence, the subtitle decoder 20, in cooperating with the analysis device 10, pre-scans subtitle units and stores the start time and finish time of every sentence scanned in the circular buffer 60. The display system will retrieve the start time of the sentence from the circular buffer 60 under the guidance of the indexer and then jump to (GoToTime) the start of the sentence to play as usual.

Wherein, Forward Sentence (FS) and Backward Sentence (BS) in the embodiment of the present invention are explained in terms of the sentences immediately before and after the current sentence, respectively. However, it is purely for the purpose of explanation and it is not intended to limit the number of sentences for the commands of Forward Sentence (FS) and Backward Sentence (BS). As described earlier, as long as the size of the circular buffer 60 is large enough, start time and finish time of more sentences can be stored in the circular buffer 60 before hand.

Consequently, with the method for separating sentences in an audio-video display system according to the present invention, a circular buffer is used to store start time and finish time of the last sentence, the current sentence, and the next sentence, respectively and users may use an user interface to accurately conduct repeat sentence, forward sentence, backward sentence, or directly jump to a certain sentence for playing to facilitate users to learn a language.

While the invention has been described with reference to the a preferred embodiment thereof, it is to be understood that modifications or variations may be easily made without departing from the spirit of this invention, which is defined by the appended claims.

What is claimed is:

1. A method for separating sentences in an audio-video display system, wherein the audio-video display system comprises at least an analysis device, a subtitle decoder, a video decoder, a video synthesizer, and an audio decoder, comprising the following methods:
the detection of sentence labels: when the audio-video display system is playing, a subtitle decoder may use the information of a subtitle unit to detect the start time and finish time of a sentence;
the management of sentence label: a circular buffer is provided to store the sentence label of the sentence and an index is maintained to access the buffer; and
the display of sentence label: when the audio-video display system is playing, an instruction of a control device can be used to retrieve the label of a sentence requested for displaying from the circular buffer and to display the sentence.

2. The method for separating sentences in an audio-video display system as defined in claim 1, wherein the label of the sentence is the start time and finish time of the sentence.

3. The method for separating sentences in an audio-video display system as defined in claim 1, wherein the circular buffer further comprises an indexer to facilitate the display system to obtain the sentence label of the sentence requested for displaying.

4. The method for separating sentences in an audio-video display system as defined in claim 1, wherein the subtitle buffer stores the start time and finish time of every sentence in the circular buffer.

5. The method for separating sentences in an audio-video display system as defined in claim 1, wherein the control device is buttons of a remote controller or input interface.

6. The method for separating sentences in an audio-video display system as defined in claim 1, wherein the audio-video display system can conduct the functions of Repeat Sentence (RS), Forward Sentence (FS), Backward Sentence (BS), and GoTo Sentence (GS) according to the instructions of the control device.

7. The method for separating sentences in an audio-video display system as defined in claim 6, wherein the repeat sentence is achieved by that the audio-video display system retrieves the sentence label of the current sentence from the circular buffer and then conducts repeat sentence; the backward sentence is achieved by that the audio-video display system retrieves the sentence label of the last sentence from the circular buffer and then plays as usual; the forward sentence is achieved by that the audio-video display system retrieves the sentence label of the next sentence from the circular buffer and then plays as usual; and the GoTo Sentence is achieved by that the subtitle decoder, in cooperating with the analysis device, pre-scans subtitle units and stores the start time and finish time of every sentence scanned in the circular buffer, and the display system will retrieve the start time of the sentence from the circular buffer under the guidance of the indexer and then jump to (GoToTime) the start of the sentence to play as usual.

8. A method for separating sentences in an audio-video display system, wherein the audio-video display system comprises at least an analysis device, a subtitle decoder, a video decoder, a video synthesizer, and an audio decoder, comprising the following methods:
a circular buffer is provided;
when the audio-video display system is playing the current sentence, the subtitle decoder, in cooperating with an analysis device, pre-scans the labels of the sentences immediately before and after the current sentence to detect their labels;
the sentence labels of the current sentence, and the sentences immediately before and after the current sentence are stored in the circular buffer; and
when the audio-video display system is playing, the audio-video display system may retrieve the sentence label of a sentence which is requested for playing from the circular buffer and play the sentence.

9. The method for separating sentences in an audio-video display system as defined in claim 8, wherein the sentence label represents the start time and finish time of the sentence

10. The method for separating sentences in an audio-video display system as defined in claim 8, wherein the circular buffer further comprises an indexer to facilitate the audio-video display system to obtain the sentence label of the sentence requested for playing.

11. The method for separating sentences in an audio-video display system as defined in claim 8, wherein the audio-video display system adopts an interleave style of playing the current sentence and at the same time scanning the subtitle information.

12. The method for separating sentences in an audio-video display system as defined in claim 8, wherein the control device is buttons of a remote controller or input interface.

13. The method for separating sentences in an audio-video display system as defined in claim 8, wherein the audio-video display system can conduct the functions of Repeat Sentence (RS), Forward Sentence (FS), Backward Sentence (BS), and GoTo Sentence (GS) according to the instructions of the control device.

14. The method for separating sentences in an audio-video display system as defined in claim 13, wherein the repeat sentence is achieved by that the audio-video display system retrieves the sentence label of the current sentence from the circular buffer and then conducts repeat sentence; the backward sentence is achieved by that the audio-video display system retrieves the sentence label of the last sentence from the circular buffer and then plays as usual; the forward sentence is achieved by that the audio-video display system retrieves the sentence label of the next sentence from the circular buffer and then plays as usual; and the GoTo Sentence is achieved by that the subtitle decoder, in cooperating with the analysis device, pre-scans subtitle units and stores the start time and finish time of every sentence scanned in the circular buffer, and the display system will retrieve the start time of the sentence from the circular buffer under the guidance of the indexer and then jump to (GoToTime) the start of the sentence to play as usual.
